(19) United States
(12) Patent Application Publication
(10) Pub. No.: US 2008/0044127 A1
(43) Pub. Date: Feb. 21, 2008

(54) Printed Circuit Board Element Comprising at Least One Optical Waveguide, and Method for the Production of Such a Printed Circuit Board Element

(75) Inventors: Gunther Leising, Graz (AT); Arno Klamminger, Graz (AT); Gregor Langer, Graz (AT); Volker Schmidt, Pischelsdorf (AT); Riikka Reitzer, Jyvaskyla (FI)

Correspondence Address: LADAS & PARRY, 26 WEST 61ST STREET, NEW YORK, NY, 10023, US

(73) Assignee: AT & S AUSTRIA TECHNOLOGIE & SYSTEMTECHNIK AKTIENGESELLSCHAFT, Leoben-Hinterberg (AT)

(21) Appl. No.: 10/581,849

(22) PCT Filed: Dec. 28, 2004
(86) PCT No.: PCT/AT04/00459

§ 371 Date: Oct. 16, 2007

(30) Foreign Application Priority Data
Dec. 29, 2003 (AT) 2096/2003

(51) Int. Cl. G02B 6/43; G02B 6/12

(52) U.S. Cl. 385/14

(57) ABSTRACT

Disclosed is a printed circuit board element comprising an optical waveguide and an embedded optoelectronic element.

The invention relates to a printed circuit board element including at least one optical waveguide provided in an optical layer and at least one optoelectronic component in optical connection with the optical waveguide.

Furthermore, the invention relates to a method for producing such a printed circuit board element.

In electronics, both the speed and the complexity of electronic components like processors increase very rapidly, and this increase in performance also entails a tremendous increase in the data rates at which these electronic components are fed and communicate with other components. The transmission of the necessarily high data quantities constitutes a special challenge to the signal connections between the individual components. To meet these demands, optical signal connections in printed circuit boards have already been proposed.

WO 01/16630 A1, for instance, discloses a printed circuit board element which is constructed as a conventional multi-layer printed circuit board, yet includes an optical waveguide layer. That known printed circuit board element, in detail, is conventionally provided with electronic components on its outer side, while optoelectronic components in the form of a laser element and a photodiode are embedded in the interior of the printed circuit board structure and are electrically connected with the external electronic components. These optoelectronic components are arranged in a buffer layer adjacent an optical waveguide layer, and that optical waveguide layer includes mirrors or grating structures in alignment with the optoelectronic components for the optical transmission of signals in order to accordingly deflect the laser beam or light beam into the optical waveguide layer or out of the same. However, this involves the disadvantage that the alignment of the optoelectronic components and the deflection elements is critical during manufacture and that, moreover, losses due to the passive optical deflection elements have to be taken into account. The optical waveguide layer, in particular, is made of a polyimide material which is applied by spin-coating and cured at an elevated temperature while forming two-dimensional optical waveguide structures within which the respective laser beam is aligned by the aid of the passive deflection elements etc. To this end, it is, thus, also essential that a perfectly collimated laser beam be generated by the laser component.

On the other hand, it has already been known, for instance, from WO 01/96915 A2, WO 01/96917 A2 and U.S. Pat. No. 4,666,236 A to produce by photon absorption processes optical waveguide structures in an organic or inorganic optical material, which is, for instance, present in block form, whereby the optical material, when irradiated with photons, is locally converted in a manner as to have a higher refractive index than the remaining optical material. The known optical waveguide structures are used as opto-coupler components for coupling fiber optic cables with one another or with optoelectronic components. These known opto-coupler components, therefore, can only be used in very special cases.

A basically comparable optical component comprising a wave-guide, yet no optically structured waveguide layer, is disclosed in U.S. Pat. No. 4,762,381 A. Also there, the approach is to provide a technology for coupling light into an optical fiber with a light source being directly embedded in the material of the optical fiber.

In addition, it is known from EP 1 219 994 A2 to incorporate a two-dimensional waveguide layer in a semiconductor device comprising a laminar substrate, with the electrooptic components being arranged on the surface of the waveguide layer; in that case, only limited applications of the semiconductor devices are feasible in each case. A similar integrated circuit is described in US 2002/0081056 A1, wherein a multilayer optical layer comprising a core layer between sheath layers is provided on a semiconductor substrate. An optoelectronic component is arranged in one of the sheath layers, i.e., not in the core layer, which constitutes the optical waveguide proper.

It is the object of the invention to provide a printed circuit board element of the initially defined kind and a method for producing such a printed circuit board element, wherein the construction of the printed circuit board element is simple and its production is easy and, in particular, uncritical in respect to the positioning of the individual elements, and optical losses are, moreover, minimized with the printed circuit board element in operation.

To solve this object, the printed circuit board element according to the invention, of the initially defined kind is characterized in that the optoelectronic component is embedded in the optical layer and the optical waveguide structured by irradiation within the optical layer adjoins the optoelectronic component.

Correspondingly, the method according to the invention for producing such a printed circuit board element is characterized in that at least one optoelectronic component is mounted to a substrate, that an optical layer comprised of an optical material changing its refractive index under photon irradiation is subsequently applied to the substrate while embedding the optoelectronic component in the optical layer, and that, thereafter, a waveguide structure adjoining the optoelectronic component is produced in the optical layer by photon irradiation.

Advantageous embodiments and further developments are defined in the subclaims.

The technology according to the invention provides optoelectronic components that are directly embedded in the optical layer, i.e., the surface-mounting of such components is avoided. Hence results that the positioning of these optoelectronic components is not critical and that even the alignment of the optical waveguide structure is comparatively uncritical. Since the optoelectronic components are directly embedded in the optical layer and the waveguide structure is, thus, actually provided immediately contiguous to these optoelectronic components, not only a simplified structure doing without mirrors, gratings and the like results, but also a lower structural height of the printed circuit board element has become feasible apart from the fact that losses on account of such passive optical elements like mirrors and gratings are avoided. Thus, multilayer printed circuit boards having integrated optical signal connections have become feasible, which enable the transmission of large data quantities between components and modules such as, for instance, processors and memories. Data transmission rates of far beyond 10 Gbit/s are, for instance, attainable. Another advantageous effect is the possibility to combine conventional printed circuit board techniques using conductor connections of copper, on the one hand, and optical signal connections where large data amounts are to be transmitted, on the other hand, wherein, in the main, printed circuit board structures capable of being mounted in electronic data processing plants in the same manner as conventional printed circuit boards, for instance so-called mother boards, are feasible too.

When structuring the optical waveguide within the optical layer, it may advantageously be proceeded in a manner that the optoelectronic component already embedded in the optical layer is targeted, and determined in terms of position, by a camera or similar optical vision unit; via this vision unit, a radiation unit including a lens system is subsequently controlled to displace the focal area of the emitted photon beam, in particular, laser beam, in the plane of the printed circuit board element, i.e., in the x/y plane, on the one hand, and to adjust the same also in terms of depth within the optical layer, i.e., in the z-direction, on the other hand. Using the respective optoelectronic component as a reference element, the optical waveguide can, thus, be designed as desired within the optical layer, for instance, as a simple, straight optical waveguide connection or as a waveguide structure having branches or similar structures or, in particular, even as a three-dimensional structure. The cross-sectional dimensions of the thus structured optical waveguide can, for instance, be on the order of some micrometers, possible cross sections of thus structured optical waveguides including, for instance, elliptical to rectangular cross sections; the exact shape can be determined by the photon beam and its focus control.

In a preferred manner, a two-photon process (two-photon absorption—TPA) is applied in the technique according to the invention for the structuring of the waveguide, by which a chemical reaction (e.g. polymerization) is triggered on account of the simultaneous absorption of two photons. The optical material to be structured is transparent for the employed excitation wavelength (e.g. wavelength=800 nm) of the light source (laser). Hence, no absorption and no one-photon process will occur within the material. However, in the focal area of the laser beam, the intensity is so high that the material will absorb two photons (two-photon process) (here: wavelength=400 nm), thus triggering a chemical reaction. This offers the advantage that, due to the transparency of the optical material for the excitation wavelength, any point within the volume will be reached so as to allow three-dimensional structures to be readily written into the volume. Furthermore, nonlinear coherent and incoherent physical effects cause the self-focussing of the laser beam so as to allow for the obtainment of very small focal areas and, hence, very small structural dimensions. Besides, the two-photon process is a one-step structuring process, thus rendering multiple exposures as, e.g. according to U.S. Pat. No. 4,666,236 A, and wet-chemical development steps superfluous.

Currently available optoelectronic components, for instance, have heights of 100 μm, and this structural height also implies the (minimum) thickness for the optical layer. Particularly small structural heights will, however, be attained if optoelectronic components are produced in situ by thin-layer technology rather than using prefabricated optoelectronic components which are embedded in the optical layer.

On the other hand, it is conceivable to not only embed in the optical layer mere converter components, say, for instance, a laser component and a photodiode, as optoelectronic components, but to also integrate associated electronic components such as, e.g., a processor or a memory module, so that thus combined assemblies like, in particular, “optoelectronic chips” can likewise be embedded in the optical layer, thus optionally enabling an external insertion of components in the printed circuit board element to be simplified or even omitted. The printed circuit board element may comprise an optical-layer-carrying substrate, to which end also a printed circuit board layer conventional per se, i.e., a synthetic resin layer having a copper inner ply and/or a copper outer ply, can be provided. The optical layer can also be additionally provided with a printed circuit board layer on its side located opposite such a substrate or such a printed circuit board layer, whereby a copper inner ply and/or a copper outer ply having appropriate patterns may be provided. Thus, multilayer printed circuit board structures are provided in a manner known per se in order to achieve the respectively desired circuit functions.

Internally located conductive layers, i.e. layers located adjacent to the optical layer, can also serve as heat dissipation layers to carry thermal energy off from the respective optoelectronic component towards outside.

The optoelectronic components embedded in the optical layer may advantageously be contacted through so-called via laser bores, wherein such vias in a manner known per se may be provided with metallic wall coatings of, in particular, copper or even filled with an (electrically) conducting material, in particular copper. It is also feasible to carry heat off from the internally located, embedded optoelectronic components to the exterior through such vias and, in particular, vias that are completely filled with conductive material.

Yet, also the inner plies of printed circuit board structures or layers may be used to contact the embedded optoelectronic components as pointed out above. In this case, it is suitable if the optoelectronic components with one side abut directly on the inner ply of a printed circuit board layer. Otherwise it is, of course, also possible to completely embed the optoelectronic components in an optical layer, which will facilitate the structuring of the optical waveguide, i.e., the control of the focal points of the photon beams in the z-direction, because in this case positioning in the z-direction is not that critical.

With the printed circuit board elements according to the invention, the patterned optical waveguides virtually directly adjoin the respective optoelectronic components, wherein “directly adjoin” is meant to denote that no intermediately arranged passive elements like mirrors, gratings or the like are provided. It may, however, also happen in individual cases that the respective optical waveguide is produced by leaving a slight distance, for instance, on the order of 0.5 μm or 1 μm relative to the optoelectronic component, while nevertheless enabling the “capture” of the light emitted by the optoelectronic component, or the coupling of the transmitted light into the neighboring optoelectronic component, without any substantial optical losses. It is, furthermore, conceivable to provide a photonic light-diffractive crystal structure on the end of the optical waveguide as a transition to the optoelectronic component in order to achieve by said photonic crystal structure the optimum light concentration possible. Other options for connecting the optical waveguide to the optoelectronic component include the funnel-like widening of the end of the optical waveguide or the at least partial, optionally whole, enclosure of the optoelectronic component by the same.

Within the scope of the invention it is further possible to devise the present printed circuit board element as a flexible printed circuit board element, i.e., without any rigid substrate or the like but substantially merely as a, for instance, two-ply optical layer comprising at least one totally embedded optoelectronic component and lateral connections for the same, wherein it is feasible to subsequently attach, e.g. glue, such a flexible printed circuit board element, for instance, to a carrier such as a housing wall of an electric appliance.

In the following, the invention will be explained in more detail by way of preferred exemplary embodiments to which it is, however, not limited, and with reference to the drawing.

### Therein:

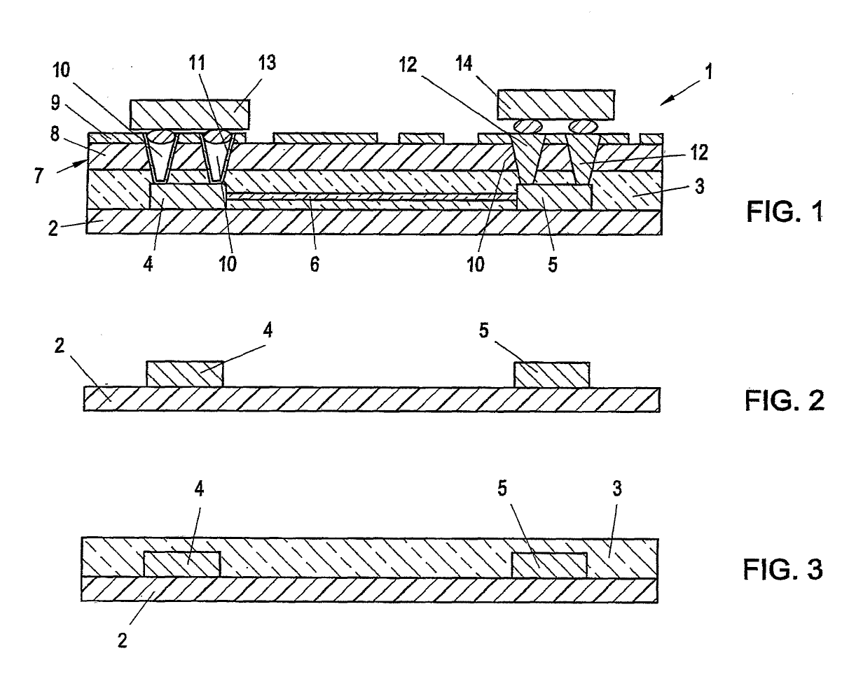

FIG. 1 is a schematic cross section through an embodiment of a printed circuit board element according to the invention;

FIGS. 2 to 7 depict various production stages in the production of a printed circuit board element as illustrated in FIG. 1;

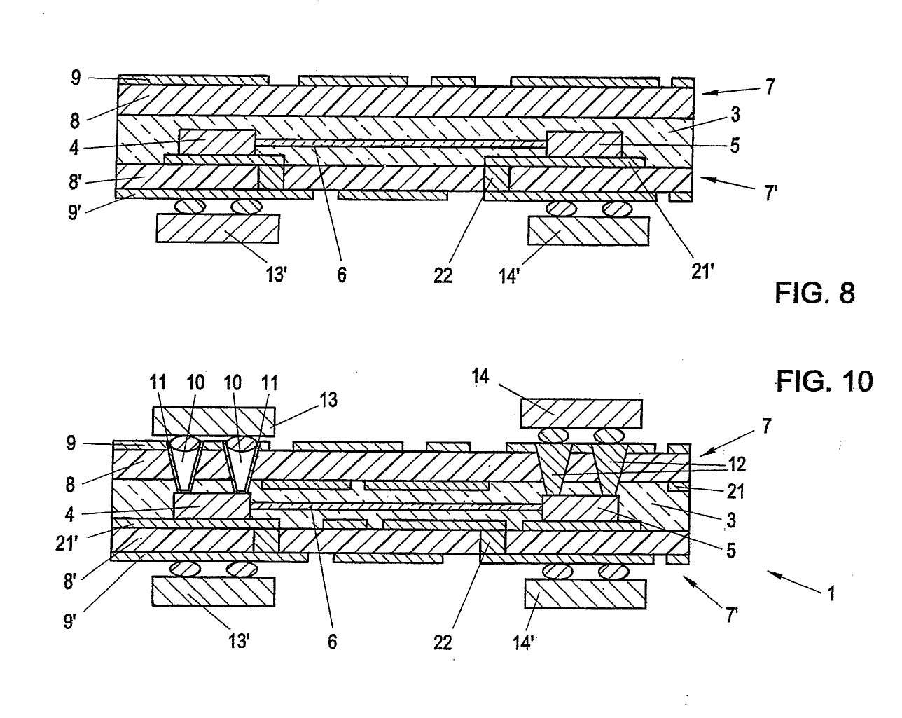

FIGS. 8 and 9 represent two further embodiments of printed circuit board elements according to the invention, in schematic cross-sectional illustrations similar to that of FIG. 1;

FIG. 10 depicts still another embodiment of a printed circuit board element according to the invention in a cross-sectional illustration, with different configuration options being combined;

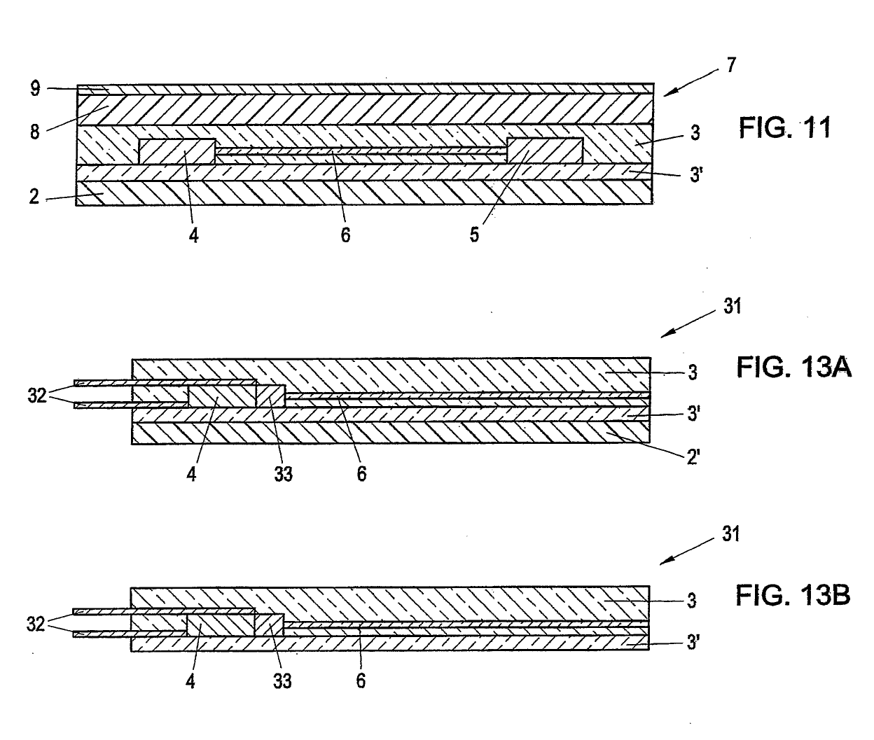

FIG. 11 in a cross-sectional illustration comparable to that of FIG. 5 represents a printed circuit board element having an intermediate layer provided between the substrate and the optical layer;

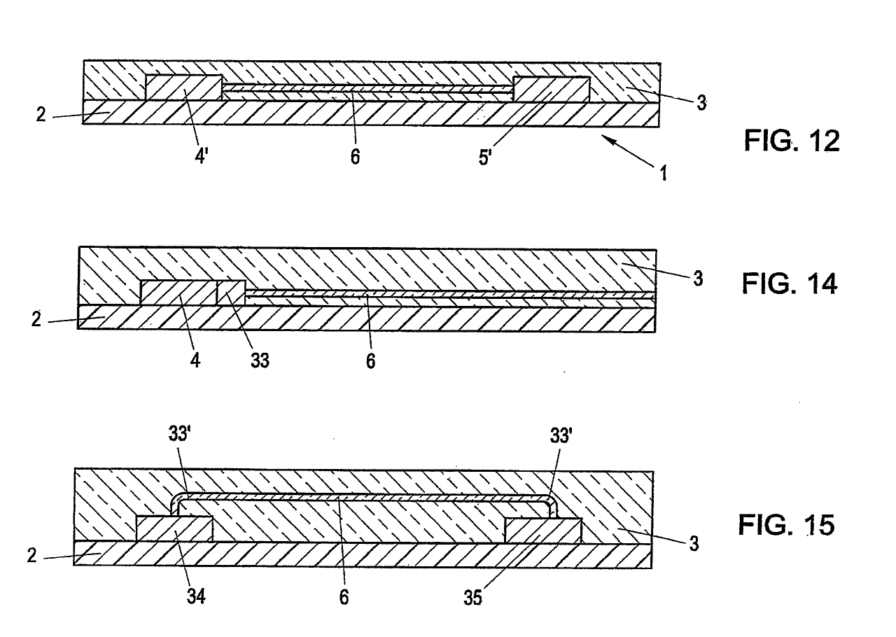

FIG. 12 in an illustration similar to that of FIG. 3 shows an intermediate stage in the production of a printed circuit board element, for which the manufacture of optoelectronic components is realized in situ by thin-film technology rather than embedding prefabricated optoelectronic components;

FIGS. 13A and 13B in similar cross-sectional illustrations depict a flexible printed circuit board element (FIG. 13B), with the substrate used during the production and removed thereafter being still apparent from FIG. 13A;

FIG. 14 in cross section illustrates a simplified printed circuit board element with a single optoelectronic component, wherein, for the sake of improved clarity, also the transition between the optoelectronic component and the structured optical waveguide has been entered;

FIG. 15 is a schematic cross section of a printed circuit board element with a VCSEL laser and an accordingly structured optical waveguide;

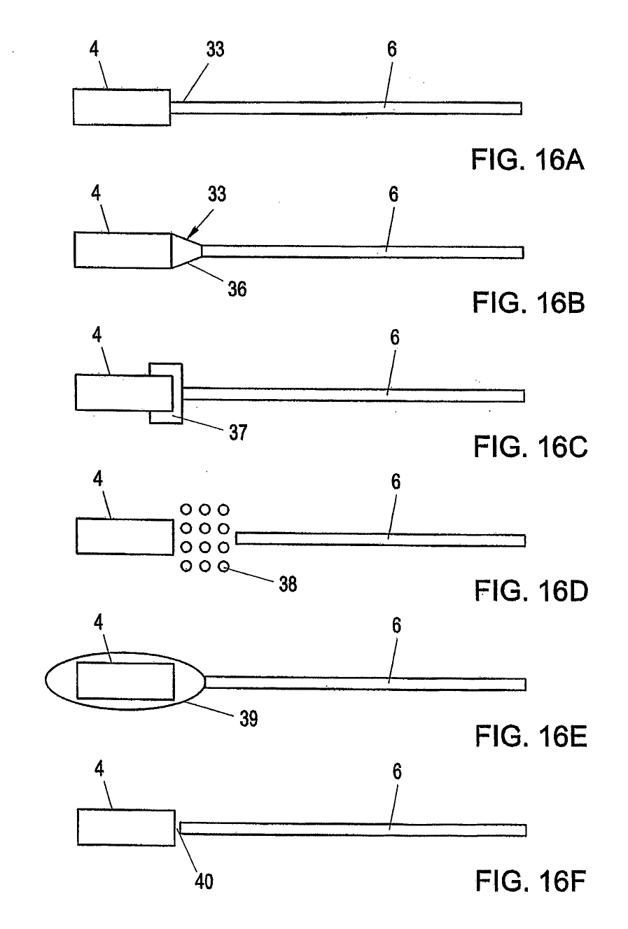

FIGS. 16A to 16F schematically illustrate various options for connecting a structured optical waveguide to an optoelectronic component; and

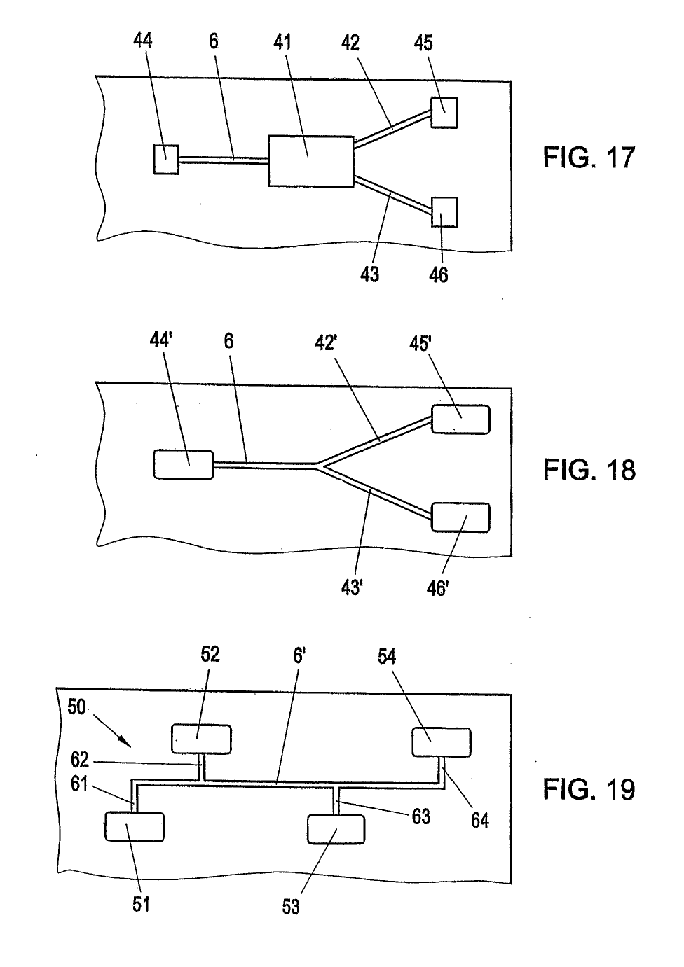

FIGS. 17, 18 and 19 are schematic top views on various options for forming structures using optoelectronic components and structured optical waveguides.

FIG. 1 fully schematically, in an out-of-scale cross sectional view, shows the structure of a printed circuit board element 1 where external components have already been inserted; yet, it should be pointed out that such an insertion of components is, as a rule, effected only immediately prior to mounting in an appliance at the appliance manufacturer, and that printed circuit board elements without inserted components, as apparent, for instance, from FIG. 7 are actually marketed. “Printed circuit board elements”, therefore, are to be understood as encompassing also elements without external components as well as elements where no such insertion of external components will take place at all, cf., e.g., FIG. 9, right-hand side.

The printed circuit board element 1 schematically illustrated in FIG. 1 comprises a substrate 2 such as, for instance, a conventional FR4 substrate containing an epoxy resin layer. Above the substrate 2, there is provided an optical layer 3 which is at least substantially transparent for the wavelengths employed in the manufacturing process to be described in detail below and in operation, and is, for instance, made of an inorganic or organic material. A known optical material that is well-suited for the present printed circuit board element 1 is an inorganic-organic hybrid material, e.g. an organically modified ceramic material prepared by means of a sol-gel process. Another known material comprises an inorganic-organic hybrid glass likewise produced by a sol-gel process and doped with a photoinitiator (benzyldimethylketal). That hybrid glass consists of methylacrylate with a silica/zirconium network. Further known materials include photosensitive imides or polyimides and organosilsesquioxanes.

In the example illustrated in FIG. 1, two optoelectronic components 4, 5 are embedded in this optical layer 3, said two components 4, 5 resting on the substrate 2 and, in addition, being enclosed by the material of the optical layer 3. Between the two optoelectronic components 4, 5 extends an optical waveguide 6 structured by local structuring, namely by local polymerization under light energy supply. In detail, component 4 may, for instance, be a laser diode, whereas component 5 may be a photo-detector, i.e, a photodiode.

Above the optical layer 3 there is provided a printed circuit board layer 7, namely an epoxy resin layer 8 or similar insulation layer, including, for instance, an electrically conductive external layer 9, which has already been patterned as in accordance with FIG. 1 and is usually made of copper. The optoelectronic components 4, 5 are contacted through this printed circuit board layer 7 as well as the optical material of the optical layer 3 provided above the components 4, 5 via micro-via (μvia) laser bores 10, the inner walls of said micro-vias 10 being optionally provided either with a copper coat 11 or with a copper filling 12. Via this copper material present in the μvias 10, an electrical connection is established between the optoelectronic components 4, 5, on the one hand, and the patterned outer layer 9 or external electronic components 13, 14 applied to the printed circuit board element 1, on the other hand, said components 13, 14 being, for instance, soldered to the printed circuit board element 1 or attached to the same by the aid of a conductive adhesive as known per se. The external components 13, 14 may, for instance, comprise a processor module 13 or a memory module 14, the processor module 13 writing data into the memory module 14 via the optical signal connection formed by elements 4, 6 and 5; a similar optical signal connection (in the reverse direction; not illustrated) can be provided to read out data.

If the micro-vias 10 are filled with copper as illustrated in FIG. 1 at 12, this offers the advantage of obtaining a good heat dissipation from the embedded optoelectronic components towards the upper layer as illustrated in FIG. 1 in respect to the component 5 shown on the right-hand side. As will be explained in more detail below, e.g. by way of FIG. 8, also other measures for the dissipation of heat may be taken in addition or instead, if desired.

Individual steps for the production of a printed circuit board element 1 as illustrated in FIG. 1 are represented in FIGS. 2 to 7, and a method for producing such a printed circuit board element will now be explained by way of example with reference to FIGS. 2 to 7.

According to FIG. 2, it is departed from a substrate 2 such as, for instance, the already mentioned FR4 substrate comprising epoxy resin, and the optoelectronic components 4, 5 such as, for instance, a laser diode and a photodiode, are applied, e.g. glued, to said substrate 2.

After this, as illustrated in FIG. 3, material for the optical layer 3 is applied onto the substrate 2, for instance, by casting or spin-coating as known per se. This optical layer 3 is comprised of a photoreactive polymer etc., as already explained above, wherein the material is locally converted by photon irradiation in a manner as to achieve a comparatively high refractive index.

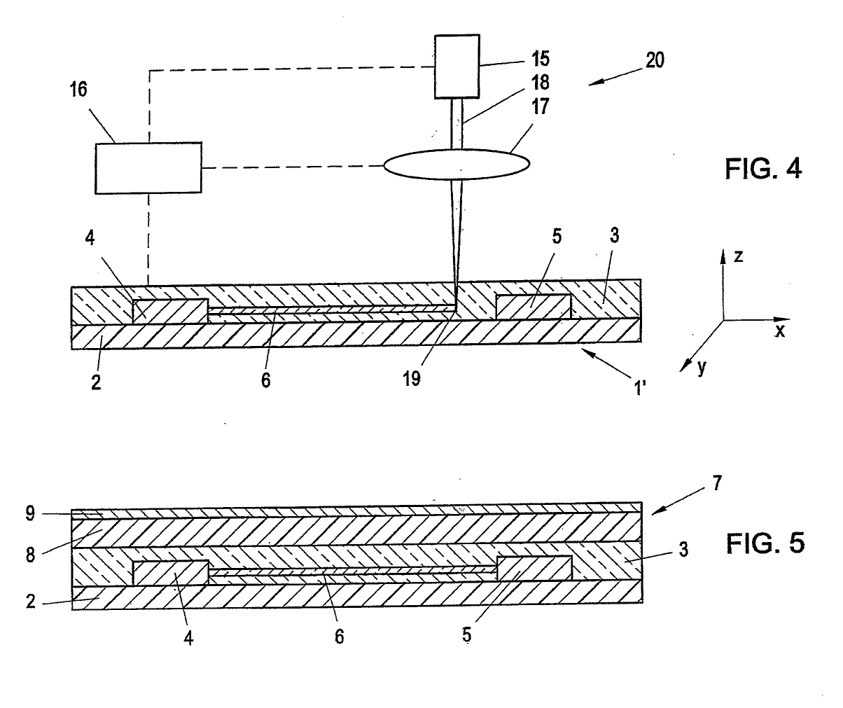

This local conversion of the photoreactive material of the optical layer 3 by the aid of photon beams is schematically illustrated as the subsequent step in FIG. 4. From the latter, a light source 15, e.g. a laser source, is apparent, which is coupled with a vision unit 16, and has in front of it a lens system 17 to focus the emitted laser beam 18 in a focal area 19 located within the material of the optical layer 3.

In detail, this structuring of the optical layer 3 using the vision or targeting unit 16 by departing, for instance, from the one, 4, of the optoelectronic components whose coordinates are determined, comprises the measuring of the distances on the specimen 1′ constituted by the printed circuit board element (to the extent present) and the controlling of the relative movement between this specimen 1′ and the lighting system 20 constituted by the laser source 15 and the lens system 17 not only in the plane of the specimen 1′, namely in the x and y directions, but also in the thickness direction of the specimen 1′, i.e. in the z-direction, in order to obtain the focal area of the laser jet 18 on the desired location within the optical layer 3. In a preferred manner, the specimen 1′0 is moved in all three directions x, y and z in order to displace the focal area 19 in the desired manner relative to the specimen 1′ within the latter and, hence, locally convert the optical material by photon irradiation; in this manner, the structured optical waveguide 6 is formed. In the focal area 19, the intensity of the laser light is, in fact, so high as to induce a two-photon absorption process as known per se. This process causes the optical material of the optical layer 3 to react (polymerize) in a manner as to form the optical waveguide 6, which has a higher refractive index than the material surrounding the same, of the optical layer 3. Hence, an optical waveguide 6 similar to a fiber optic cable is obtained, whereby, at a light transmission by appropriate reflections of the light at the interface: optical waveguide 6/surrounding material, a collimated light transmission without major optical losses is achieved.

In the next step, the upper printed circuit board layer 7 with an epoxy resin layer 8 and a copper outer ply 9 is applied to the optical layer 3, particularly by pressing, and the result of this method step is illustrated in FIG. 5.

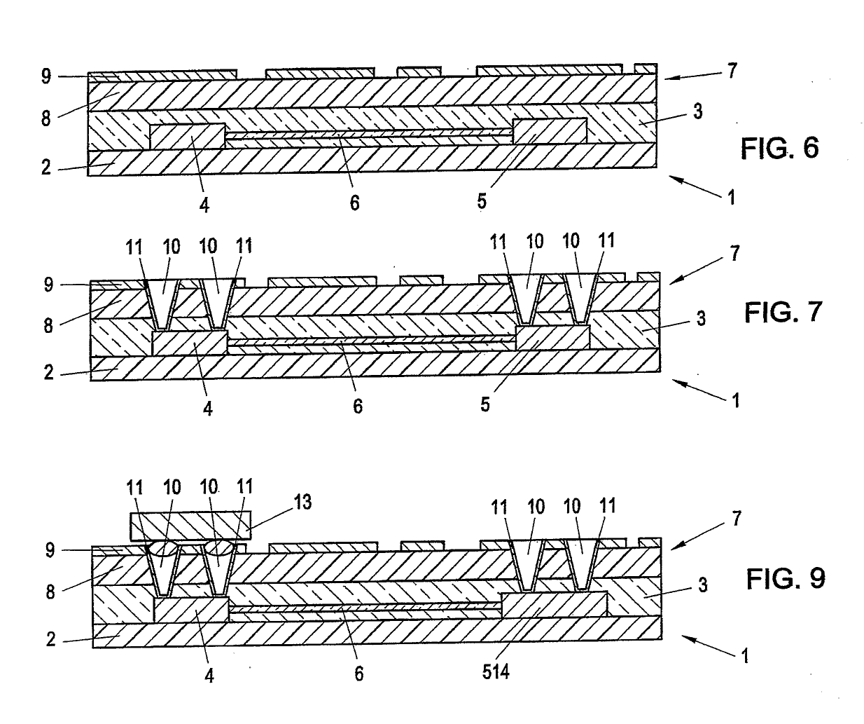

After this, as in accordance with FIG. 6, the copper outer ply 9 is patterned in the desired fashion by a conventional photolithographic procedure in order to provide the electrical traces and connection pads required according to the respective purpose of use of the printed circuit board element 1. (As known, such a photolithographic patterning process initially comprises the application of a photoresist lacquer, which is exposed through a photomask and subsequently developed, whereupon, for instance, the copper regions not protected by the converted photoresist lacquer are etched off; finally, the remaining resist lacquer is removed.)

According to FIG. 7, the micro-vias 10 are finally provided by the aid of laser beams, and are copper-plated, i.e. provided with copper coats 11, on their inner walls. Optionally, the vias 10 can also be filled with a copper material as explained by way of FIG. 1, in order to thereby obtain an enhanced dissipation of heat through such a copper filling 12 in addition to the electrically conductive connection.

Thereby, a printed circuit board element 1 without inserted components is obtained. As already mentioned, the respectively component-equipped printed circuit board element 1 is illustrated in FIG. 1. According to this exemplary embodiment, the insertion of the external electronic components 13, 14 is effected on the upper side of the printed circuit board element 1, as in accordance with the illustration in the drawing, which should, however, be understood merely as an example. Theoretically, it is also conceivable to insert components on the lower side of the printed circuit board element 1 instead or additionally, in which case a conventional printed circuit board layer structure, such as an FR4 substrate, having a copper outer ply is again used as a substrate 2, cf. FIG. 8. Additionally, such a printed circuit board layer, as the printed circuit board layer 7′ in FIG. 8, can also be provided on its upper side with a distribution layer 21′ or inner ply, besides the epoxy resin layer 8′ and the outer ply 9′. This distribution layer 21′, which can be obtained in its final form by comparable photolithographic patterning, preferably is not only used to produce the electric connections of the optoelectronic components 4 and 5 as illustrated in FIG. 8 (with the resulting advantage that the exact positioning of the connection bores as in the case of the micro-vias 10 may be obviated, since only the distribution layer 21 rather than the integrated components 4, 5 themselves has to be contacted), but also provides for a suitable way of heat dissipation. In this case, the internally located distribution layer 21′ is connected with the outer ply 9′ by copper-filled bores 22, which may be provided on more or less arbitrarily chosen spots, namely where space is available. To this outer ply 9′, the external electronic components, e.g. again a processor module 13′ and a memory module 14′, are finally mounted.

It is also conceivable to combine into a component unit electronic components, i.e. components receiving, processing and transmitting electronic data in the broadest sense, and the optoelectronic component substantially accomplishing the optical/electrical data conversion (in whatever direction). FIG. 9 shows the embedding of such a component unit 514 containing, for instance, a combination of the optoelectronic component 5 and the external electronic component 14. Thus, an optoelectronic chip is directly embedded in the optical layer 3, whereby both optical and electronic data are processable in said chip and, hence, a subsequent external equipment will be obviated so as to gain additional space for other components on the outer side of the printed circuit board element 1. The unit 514, in turn, may be connected with a copper outer ply 9 through micro-vias 10 having metal coatings 11 so as to establish electrical links. For the rest, the embodiment according to FIG. 9 is identical with that of FIG. 1 such that no further explanations are necessary.

FIG. 10 shows a combination of the configuration and insertion options previously elucidated by way of FIGS. 1 to 8; this embodiment, thus, comprises an upper printed circuit board structure 7 having an outer ply 9 and an inner ply 21 as well as a lower printed circuit board structure 7′ having an outer ply 9′ and an inner ply 21′, with the optical layer 3 arranged therebetween, and the equipment of the thus modified printed circuit board element 1 with electronic components 13, 14 and 13′, 14′ is realized both on the upper outer side and on the lower outer side. Incidentally, optoelectronic components 4, 5 are again embedded in the optical layer 3 and directly connected with each other by a locally designed optical waveguide 6 as previously described, without any passive optical element arranged therebetween.

In the embodiment according to FIG. 11, in an illustration similar to that of FIG. 5, yet deviating from FIG. 5 to the extent that an intermediate layer 3′ is shown on the substrate 2, and the optical layer 3 is only applied to this intermediate layer 3′. The optoelectronic components 4, 5 rest on the intermediate layer 3′ and, for the rest, are again embedded in the optical layer 3. On this optical layer 3 is again provided a printed circuit board structure 7 with an epoxy resin layer 8 and a copper outer ply 9. The intermediate layer 3′ may be comprised of a conductive, or else insulating and, in particular, also photoreactive, optical material, wherein, in the latter case, the two layers 3, 3′ together constitute an optical layer 3-3′ in whose material the optoelectronic components 4, 5 are embedded all-round. According to FIG. 11, the locally structured optical waveguide 6 extends again between the optoelectronic components 4, 5.

As a variation, it is, of course, also feasible to attach the optoelectronic components 4, 5 to the substrate 2 and subsequently apply the—optical—intermediate layer 3′ as well as the layer 3.

FIG. 12, in an illustration similar to that of FIG. 4, depicts a modified printed circuit board element 1 having a lower substrate 2, yet without upper printed circuit board structure, wherein, in a manner deviating from the first embodiment, the optoelectronic components 4′, 5′ embedded in an optical layer 3 are now comprised of thin-film technique components. These thin-film components 4′, 5′ are assembled on the substrate 2 in situ by processes known per se, before the optical layer 3 is applied and the optical waveguide 6 is subsequently produced in this optical layer 3 in the above-described manner, structured by photon irradiation. Further mounting may then be effected in a manner similar to what has been described above by way of FIGS. 5 to 7, FIG. 8 etc., yet it is also conceivable to provide a printed circuit board element 1 without external printed circuit board patterns having a copper outer ply and/or inner ply and, in particular, even without being equipped with electronic components on its upper and/or lower outer sides.

Thus, a simple, flexible printed circuit board element 31 is shown in FIG. 13B, which printed circuit board element 31 is previously assembled on a carrier substrate 2′, which is apparent from FIG. 13A. The printed circuit board element 31 may comprise an intermediate layer 3′ and the optical layer 3, wherein also the intermediate layer 3′ may be formed by an optical layer of a comparative, transparent, optical, photoreactive material, or even by any other synthetic layer. The substrate 2′, which is shown in FIG. 13A, is removed after the completion of the printed circuit board element 31 so as to obtain a flexible laminate comprised of layers 3, 3′, which can be extremely thin like a film. This flexible printed circuit board element 31 can be applied to a base like, for instance, the inner side of a housing of an electric appliance in order to utilize this space for electric circuits.

In the example according to FIGS. 13A and 13B, just a single optoelectronic component 4 is illustrated, which is applied on the intermediate layer 3′; prior to the application of the optical layer 3 in the manner previously explained by way of FIG. 3, connections 32 to the optoelectronic component 4 are established, for instance by bonding with copper wires.

It is further apparent from FIGS. 13A and 13B that the optical waveguide 6, which is again produced as explained by way of FIG. 4, adjoins the optoelectronic component 4 via a transition region 33, an interface, said transition region 33 being simultaneously produced with the optical waveguide 6 by photon irradiation as described.

A comparable transition region 33 is also shown in the embodiment according to FIG. 14, wherein a double-layer structure including a substrate 2 and an optical layer 3 is illustrated, and wherein only a single optoelectronic component 4 to which the optical waveguide 6 is connected via the transition region 33 is again shown. The substrate 2 in this case may comprise an outer and/or inner ply of a conductive material, which is not illustrated in detail.

Before setting out the various options for the configuration of such a transition region 33 by way of FIGS. 16A-16F, it is still referred to FIG. 15, which depicts a configuration comprising a VCSEL element 34 (VCSEL—vertical-cavity surface emitting laser) as optoelectronic component as well as a photodiode 35 with the light reception face on top, the optical waveguide 6 in this case being connected to the two optoelectronic components 34, 35—which are again embedded in an optical layer 3 applied on a substrate 2 in the described manner—via arc-shaped transition regions 33′.

FIG. 16 comprising partial FIGS. 16A to 16F schematically illustrates various options for the configuration of the end (transition region 33) adjoining the optoelectronic component, e.g. 4, of the optical waveguide 6. According to FIG. 16A, the optical waveguide 6 is “written in” so as to reach directly as far as to the component 4 to thereby provide a sharp edge on the end of the optical waveguide 6. According to FIG. 16B, the optical waveguide 6 is widened into a funnel 36 on its end or transition region 33, and according to FIG. 16C, the optical waveguide 6 in the transition region is “written in” directly around the optoelectronic component 4 with a partial enclosure being obtained in the connection region 37.

According to FIG. 16D, a photonic crystal structure 38 (including columns etc., having a periodicity in two dimensions or in three dimensions) is written in on the end of the optical waveguide 6 in the course of the described photon irradiation, said crystal structure—which is known per se as to its effect—limiting the light to a central passage and, hence enabling an optical connection from the component 4 to the optical waveguide 6, or vice versa, at extremely low losses.

According to FIG. 16E, the optoelectronic component 4 is enclosed by the optical waveguide end not only partially as in accordance with FIG. 16C, but totally as shown at 39. The exemplary embodiments according to FIGS. 16B and 16C, therefore, might also be regarded as special cases of 16E.

FIG. 16F finally demonstrates that it is also admissible to leave a—slight—interspace or gap 40 between the component 4 and the optical waveguide 6, for instance, if, during the “writing n” of the optical waveguide 6 as previously explained by way of FIG. 4, the laser beam must not be directly focussed on the component 4. Such a gap 40 can, for instance, be on the order of 1 μm without affecting the function.

Finally, several examples of optical signal connections including optoelectronic components, which may be realized in the printed circuit board element according to the invention, will be explained by way of FIGS. 17, 18 and 19. However, it goes without saying that numerous other variants of such optical signal connections including optoelectronic components and structured optical waveguides are feasible.

FIG. 17, for instance, depicts a Y-configuration for an optical signal connection, wherein, for instance, a multiplexer-/demultiplexer component 41 following an optical waveguide 6 as well as, on the other side, optical waveguides 42, 43 are shown at the junction, in order to interconnect optoelectronic components 44, on the one hand, and 45, 46, on the other hand.

Also FIG. 18 depicts a Y-configuration including two combined optoelectronic processor and memory assemblies 45′ and 46′, respectively, on the one side, and an assembly 44′, on the other side, whereby the optical waveguide 6 leading away from the assembly 44′ is branched into two branches 42′, 43′.

FIG. 19 finally depicts an optical bus system including optoelectronic transceiver assemblies 51, 52, 53 and 54, said optical bus system 50 containing a main optical waveguide 6′ and optical waveguides 61, 62, 63 and 64 branching off the same.

1. A printed circuit board element (1) including at least one optical waveguide (6) provided in an optical layer (3) and at least one optoelectronic component (4, 5; 4′, 5′) in optical connection with the optical waveguide (6), characterized in that the optoelectronic component (4, 5; 4′, 5′) is embedded in the optical layer (3), that the optical waveguide (6) adjoins the optoelectronic component (4, 5; 4′, 5′), and that the optical waveguide is structured by irradiation within the optical layer (3).

2. The printed circuit board element according to claim 1, characterized in that the optoelectronic component (4, 5; 4′, 5′) with one side borders upon a substrate (2) carrying the optical layer (3), or a cladding layer (3′; 21) applied thereon, respectively.

3. The printed circuit board element according to claim 1, characterized in that the optoelectronic component (4, 5; 4′, 5′) is on all sides embedded in the optical layer (3, 3′) formed, for instance, by two plies.

4. The printed circuit board element according to claim 3, characterized in that the optical layer (3, 3′) is realized as a flexible layer.

5. The printed circuit board element according to claim 1, characterized in that at least two optoelectronic components (4, 5; 4′, 5′) connected with each other via the optical waveguide (6) are embedded in the optical layer (3).

6. The printed circuit board element according to claim 1, characterized in that the, or at least one, optoelectronic component(s) borders upon a heat-dissipation layer (21′) by one side.

7. The printed circuit board element according to claim 6, characterized in that the heat dissipation layer (21′) is formed by a patterned inner ply.

8. The printed circuit board element according to claim 1, characterized in that the optoelectronic component (5) is combined with an associated electronic component (14) to an embedded unit (514).

9. The printed circuit board element according to claim 8, characterized in that the embedded unit (514) is an optoelectronic chip.

10. The printed circuit board element according to claim 1, characterized in that the optoelectronic component (4, 5) borders upon an electrically conductive distribution layer (21′).

11. The printed circuit board element according to claim 10, characterized in that the distribution layer (21′) is connected with at least one external electrical contact.

12. The printed circuit board element according to claim 11, characterized in that the distribution layer (21′) is connected with the at least one external electrical contact through a via (22) provided in the substrate (7′).

13. The printed circuit board element according to claim 1, characterized in that a printed circuit board layer (7, 7′) having a patterned, conductive inner ply (21, 21′) and/or outer ply (9, 9′) is applied on at least one side of the electrically insulating optical layer (3).

14. The printed circuit board element according to claim 1, characterized in that the optoelectronic component (4, 5), or optionally the unit (514), is contacted through vias (10) provided in the optical layer (3) as well as, optionally, in a printed circuit board layer (7) applied on the same.

15. The printed circuit board element according to claim 14, characterized in that an electronic component (13, 14) connected with the optoelectronic component (4, 5) is mounted to the printed circuit board layer (7).

16. The printed circuit board element according to claim 1, at least one of characterized in that the optoelectronic component (4′, 5′) is a component produced in situ by thin-film technique, characterized in that the optoelectronic component is a VCSEL component (34) to which the optical waveguide adjoins, e.g. with an arc-shaped transition (33′), characterized in that the optoelectronic component (6) is widened in a funnel-shaped manner on its end (34) adjacent the optoelectronic component (4), characterized in that the optical waveguide (6) at least partially encloses the optoelectronic component (4) on its end (37; 39) adjacent the optoelectronic component (4), or characterized in that the optical waveguide (6) is provided with a photonic light-diffractive crystal structure (38) on its end adjacent the optoelectronic component (4).

17. (canceled)

18. (canceled)

19. (canceled)

20. (canceled)

21. The method for producing a printed circuit board element (1) according to claim 1, characterized in that at least one optoelectronic component (4, 5; 4′, 5′) is mounted to a substrate (2), that an optical layer (3) comprised of an optical material changing its refractive index under photon irradiation is subsequently applied to the substrate while embedding the optoelectronic component (4, 5; 4′, 5′) in the optical layer (3), and that, thereafter, a waveguide structure (6) adjoining the optoelectronic component (4, 5; 4′, 5′) is produced in the optical layer (3) by photon irradiation.

22. The method according to claim 21, characterized in that at least two optoelectronic components (4, 5; 4′, 5′) are mounted to the substrate (2) and embedded in the optical layer (3) and thereafter are connected with each another by the optical waveguide (6) directly adjoining the same.

23. The method according to claim 21, characterized in that, after the production of the optical waveguide structure (6) in the optical layer (3), a printed circuit board layer (7, 7′) including a conductive inner ply (21, 21′) and/or outer ply (9, 9′) is applied to at least one side of said optical layer (3), characterized in that the inner ply (21, 21′) is patterned before applying the printed circuit board layer to the optical layer, or characterized in that the outer ply (9, 9′) is patterned after the application of the printed circuit board layer to the optical layer.

24. (canceled)

25. (canceled)

26. The method according to claim 23, characterized in that vias (22) are provided in the optical layer (3), optionally also in the printed circuit board layer (7, 7′), in coordination with the respective optoelectronic component (4, 5; 4′, 5′) and that electrically conductive connections to the optoelectronic component are established through said vias.

27. The method according to claim 26, characterized in that at least one electronic component (13, 14), which is conductively connected with the optoelectronic component (4, 5), is mounted to the printed circuit board layer (7) and/or the substrate.

28. The method according to claim 21, at least one of characterized in that an optoelectronic component (5) combined to a unit with an associated electronic component (14) is mounted to the substrate and embedded in the optical layer, or characterized in that the substrate (3) is provided with at least one cladding layer (3′; 21) before applying the optoelectronic component (4, 5) thereto.

29. (canceled)

30. The method according to claim 29, at least one of characterized in that a cladding layer (3′) of optical material is applied to the substrate (3), characterized in that an electrically conductive cladding layer (21′) is applied to the substrate as a distribution layer, said distribution layer being subsequently patterned, if required.

31. (canceled)

32. The method according to claim 30, at least one of characterized in that electrical connections for the optoelectronic component (4, 5) are established throughout the distribution layer, or characterized in that the distribution layer is configured as a heat-dissipation layer.

33. (canceled)

34. The method according to claim 21, at least one of characterized in that the optoelectronic component (4, 5) is produced in situ on the substrate (3) by thin-film technique, characterized in that the optical waveguide structure (6) is produced with a funnel-shaped widening (37) on its end adjacent the optoelectronic component (4), characterized in that the optical waveguide structure (6) is produced with an end region (37; 39) at least partially enclosing the optoelectronic component (4), or characterized in that the optical waveguide structure (6) is produced with a photonic light-diffractive crystal structure (38) on its end adjacent the optoelectronic component (4).

35. (canceled)

36. (canceled)

37. (canceled)
